(19) United States
(12) Patent Application Publication
(10) Pub. No.: US 2008/0203956 A1
(43) Pub. Date: Aug. 28, 2008

(54) Predictive Maintenance Method

(75) Inventor: Menachem Cohen, Tel Aviv (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: M.E.A. Testing Systems Ltd., Netanya (IL)

(21) Appl. No.: 11/911,533

(22) PCT Filed: Apr. 23, 2006
(86) PCT No.: PCT/IL06/00499

§ 371 Date: Oct. 15, 2007

(30) Foreign Application Priority Data
Apr. 25, 2005 (IL) 168232

(51) Int. Cl. G05B 19/401; G06F 11/30; G08B 21/00

(52) U.S. Cl. 318/600; 702/184; 340/648

(57) ABSTRACT

The predictive apparatus and method for preventive maintenance of rotating CNC machinery for application to a multi motor machine tooling operating under computer numerical control with provisions for a program control using the computer (22) and a multiplexing device (24) with steps for measuring the constant load momentum of inertia while running each motor and load alone from start to f speed and to the inertia idled stop while recording the performance factors and calculating a plurality of relationships with steps for setting the allowed limits to the recorded relationships and displaying the details of any relationship which falls outside the allowed limits and predicating the timely required preventative maintained schedule for the equipment (10).

### FIELD AND BACKGROUND OF THE INVENTION

The present invention relates to the field of predictive maintenance.

More particularly, the invention provides a method, an installation and a machine fitted with said installation for predictive (referred to also as preventive) maintenance of rotating machinery, the method being particularly useful for application to a multi-motor machine tool operating under Computer Numerical Control (CNC).

Many companies still run factory equipment until a machine breaks down. Spare parts needed for repair may be available from the factory store, but if not a very urgent purchase order is issued to obtain same. Production requiring the services of the machine needing repair comes to a halt, adversely affecting production in related downstream (and eventually upstream) sectors and causing various avoidable expenses such as unscheduled overtime for maintenance workers.

An improvement on this state of affairs is seen in factories where at prescheduled times once or twice a year production is stopped for a few days while technicians carry out maintenance work on all equipment thought to be requiring same. During the course of this work many decisions are made without a firm factual basis, which results in either too early or too late maintenance. Even when production is not adversely affected the costs, for example, of changing the main spindle bearings of a machine tool unnecessarily can be high. The cost of failure to do so where necessary can be even higher.

In view of this situation some companies are using predictive maintenance to reduce costs, not only the cost of the maintenance actions themselves but also in order to reduce the high costs of stopped production due to machine failure.

Predictive maintenance is carried out after measurement of factors where the values of some measurable feature change some time before breakdown, or after the passage of a running time period. A simple example could be the measurement of the length of the blackened tube area in fluorescent lighting tubes and indicating that the tube will fail soon. For example maintenance staff could be instructed that fluorescent lighting elements are to be changed where the blackened end of the tube exceeds a length of 3 cm or when light output falls to some predictable value. Such maintenance is carried out in an organized manner at a time when the needed replacement tubes are available and when little or no disturbance is caused by maintenance actions to other workers.

A review of recent US patents will serve as an assessment of the present state of the art. U.S. Pat. No. 5,963,884 to Billington et al. discloses a system for a plurality of machines, to be fitted with vibration sensors, which need to be attached to the machines at various positions. A likely difficulty is that the results from a first check to a second check after some time will not be comparable due to the vibration sensors not being replaced in their exact previous locations. Furthermore, vibration from adjoining machinery or from nearby traffic can further confuse measurements.

A complex system requiring the setting up of several databases and a knowledge base is seen in U.S. Pat. No. 6,192,325 to Piety et al. The aim of this ambitious system is to allow an unskilled user to obtain predictive maintenance requirements. Programming such a complex system so that the various nodes correctly understand each other is a problem to be faced by the system supplier. However changes are frequent in an industrial environment and effecting the corresponding changes in a system of this complexity would not be feasible for the average user.

In U.S. Pat. No. 6,453,279 Prasad et al. disclose a statistical trend generator for predictive instrument maintenance. Two sensors are used, one of which monitors the process while the second sensor is used to generate a reference signal. A disparity between signals received from the two sensors indicates a need for sensor maintenance.

The present inventor has described a method and system for performance testing of rotating machines in U.S. Pat. No. 6,591,200 which was previously disclosed in Israel Patent no 124,932. The teachings of this patent, hereby incorporated into the present application by reference, are now used as components of a new predictive maintenance system.

Ozawa in U.S. Pat. No. 6,614,353 discloses a liquid circuit having a branch attached to an automatically-controlled 3-way proportional valve. Increased opening of said valve is the factor triggering a series of further measurements, and the results are computed to generate future maintenance requirements. However, like the Prasad patent, it is not clear how these methods are applicable to rotating machinery.

### OBJECTS OF THE INVENTION

It is therefore one of the objects of the present invention to obviate the disadvantages of prior art predictive maintenance systems and to provide a low-cost installation which utilizes encoders already installed on a CNC machine tool.

It is a further object of the present invention to provide the user with information regarding a machine problem before the problem becomes evident by increased vibration.

### SUMMARY OF THE INVENTION

The present invention achieves the above objects by providing a method for producing predictive maintenance data of rotating machinery, being particularly useful for machine tools operating under CNC, and having a plurality of motors driving various functions of said machine tool, said method comprising the steps

a) providing a program and inserting a card containing said program into the computer controlling said machine tool;
b) providing a multiplexing device (MUX) and electrically connecting said MUX to each motor and to said computer;
c) measuring or inserting the calculated constant load momentum of inertia (MOI) and constant driven by each motor and its constant load,
d) successively running each motor+load alone from start to full speed and to unbraked stop;
e) recording performance factors such as speed, current, voltage drop, and torque at motor shaft;
f) calculating a plurality of relationships from the motor+constant machine specific axis acceleration the motor minus constant machine specific axis such as current/torque, torque/speed, current/speed input-power/speed, efficiency/speed results from stall up to max speed, calculating a plurality from the motor+constant machine specific axis steady state running the motor minus constant load torque-spectrum analysis, speed spectrum analysis and oscillating torque, calculating a plurality from the motor+constant machine specific axis deceleration running the motor minus constant load friction torque/speed, friction torque spectrum analysis, friction speed spectrum analysis, voltage/speed, time speed, power/speed, torque/speed and the like;
g) setting allowed limits to relationships referred to in step f);
and
h) displaying details of any relationship falling outside said limits.

Preferably the method includes

i) preparing a complete results print-out for the user.

It is advantageous that step f) further includes the retrievable storing of said relationships in said computer, and providing results in a graphical form for maintenance staff for comparison of later test results.

In case the predictive is done by a relative number it is possible to insert a constant number instead of the real momentum of inertia;

In case the motors are not running successfully any other way combined successively and parallel running could be used.

In a preferred embodiment of the present invention there is provided a method wherein data relating to motor shaft position is obtained by establishing an electrical connection between said motor shaft encoder already assembled to said motor during manufacture of said machine tool and said computer.

In a further preferred embodiment of the present invention there is provided a method wherein limits referred to in step g) are preset by the manufacturer of said machine tool.

In another embodiment of the method step h) includes the activation of an alarm responsive to receipt of data indicating an out-of-bounds relationship.

In a further embodiment a CNC machine tool is provided with a data acquisition installation according to the present invention.

In a most preferred embodiment of the present invention there is provided a data acquisition installation arranged for assembly to rotating machinery, being particularly useful for machine tools operating under CNC, said machine tool having a plurality of motors operating various functions thereof, said installation comprising

a) a program card insertable into the computer controlling said machine tool;
b) a MUX electrically connectable to the encoder of each motor and to said computer;
c) switching means for successively running each motor+constant load alone from start to full speed and to an unbraked stop;
d) recording means for performance factors such as speed, current, voltage drop, time and torque at the motor shaft;
e) calculating a plurality from the motor+constant machine specific axis acceleration the motor minus constant load current/torque, Torque/speed, current/speed input-power/speed, efficiency/speed results from stall up to max speed. Calculating a plurality from the motor+constant machine specific axis steady state running the motor minus constant load torque-spectrum analysis, speed spectrum analysis and oscillating torque. Calculating a plurality from the motor+machine specific axis load deceleration running the motor minus constant load friction torque/speed, friction torque spectrum analysis, friction speed spectrum analysis.
f) setting and display means for the allowed limits to relationships referred to in step 8e), and optionally
g) alarm means responsive to any relationship falling outside said limits.

Preferably the installation includes a shunt current-measurement device disposed between the DC power supply of said machine tool and the DC-AC inverter supplying three-phase power to a motor of said machine tool.

It will thus be realized that the novel device of the present invention serves to detect future breakdown long before vibration or inaccurate machine performance become evident. For example, if a small foreign body becomes lodged in a CNC milling machine slide, or the slide has been lubricated by a grease or oil more viscous than the manufacturers recommendations, then the additional resistance to be overcome by the motor as a result will be noticed before serious damage occurs to the machine. Using the method of the present invention, a new diagram of the speed/time relationship will show marked differences with the diagram stored in the machine's computer when the machine was new. The differences will appear as longer acceleration time and/or on the deceleration time or on the steady state time as a figure prints on one of the measured or calculate motor minus constant load results. These differences are then investigated by maintenance workers who will know from experience with machines of this type how to diagnose the problem and will effect the necessary repair in a timely manner. The moderate cost of the installation according to the invention for a CNC machine tool is a result of utilizing motor position encoders which are already in use for carrying out other machine functions. The encoder output is used in the present invention for generating data which is combined with a time record and thus provides data on acceleration, full running speed and deceleration. This data can be combined with motor current and MOI data regarding the motor and it's attached load.

MOI data is useful for calculating many relationships such as torque/speed and power/speed, and generally it need only be measured once. Possibly such information could be available from the machine tool manufacturer or all the predictive can be done relatively.

While the installation of the present invention can be retrofitted to existing CNC machine tool, best appearance and lowest cost are achieved when the machine manufacturer installs the system during production thereof before releasing the machine for sale.

### SHORT DESCRIPTION OF THE DRAWINGS

The invention will now be described further with reference to the accompanying drawings, which represent by example preferred embodiments of the invention. Structural details are shown only as far as necessary for a fundamental understanding thereof. The described examples, together with the drawings, will make apparent to those skilled in the art how further forms of the invention may be realized.

In the drawings:

FIG. 1 is a block diagram representing a preferred embodiment of the installation according to the invention;

FIG. 2 is an elevational view of one of the motors; and

FIG. 3 is a schematic view of a CNC machine fitted with the installation according to the invention.

### FULL DESCRIPTION OF THE INVENTION

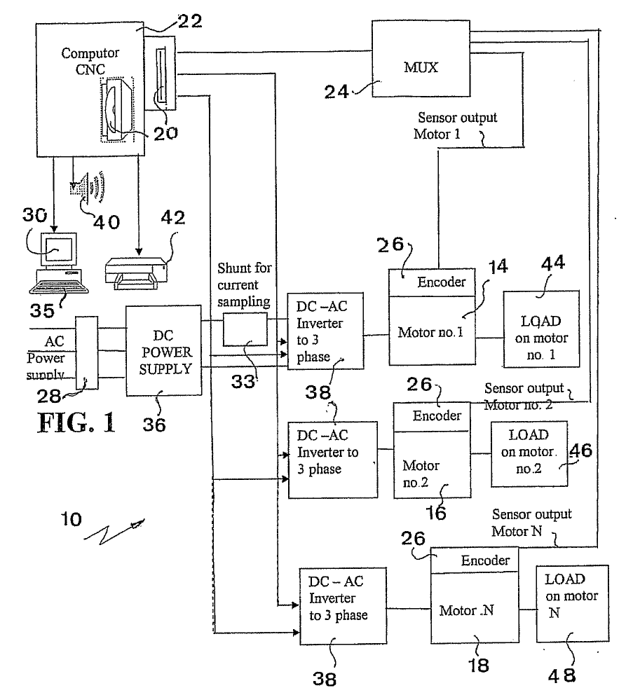

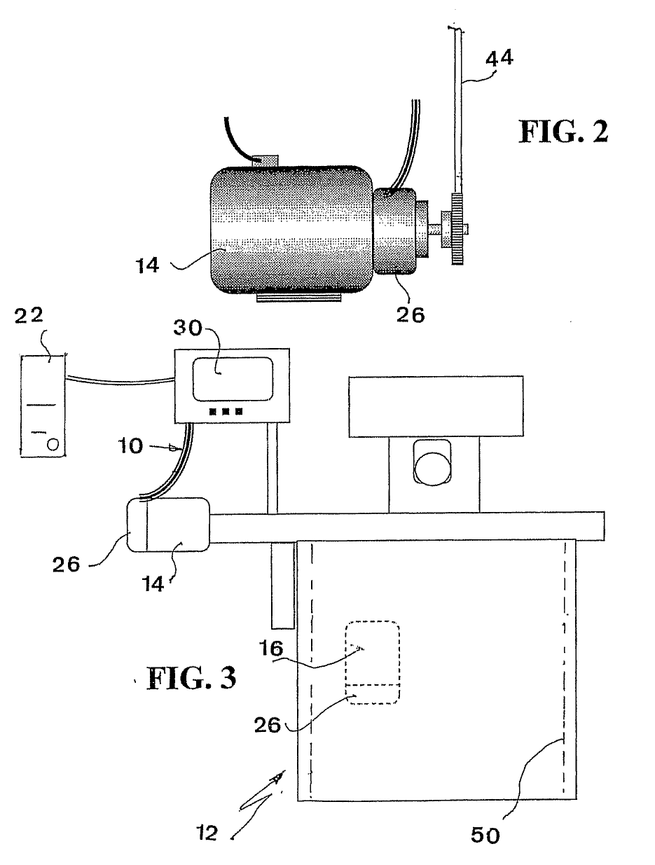

There is seen in FIG. 1 a data acquisition installation 10 arranged for assembly to a machine tool 12 (FIG. 3) operating under CNC. The machine tool 12 has a plurality of motors 14, 16, 18, see also FIG. 2, operating various functions thereof, such as slides operating each in a different direction, main spindle drive, coolant supply, rotating table drive, and others. The installation 10 includes a program card or disk 20 insertable into the computer 22 controlling the machine tool motors 14, 16, 18.

The card or disk holds a program controlling all aspects of the system. In retrofit applications, as shown here, it is preferable that the installation includes a new computer 22.

Where the manufacturer of the machine tool integrates the installation with other computer functions it is preferable that the tasks of computer 22 be carried out by the computer already installed as part of a CNC machine tool. In ether case the card or disk 20 is provided to operate the installation 10.

A multiplexer 24 is electrically connectable to the encoder 26 of each motor 14, 16, 18, and is connected to the computer 22.

Switching means 28 are provided for successively running each motor alone from start to fall speed and then to an unbraked stop.

Recording means for performance factors such as speed, current, voltage drop, and torque at the motor shaft are provided by the computer memory.

Calculating means in the computer 22 are used to find a plurality of relationships such as current/torque, voltage/speed, time/speed power/speed, torque/speed and the like. These relationships appear on the display screen 30, and optionally in a paper printed record produced by printer 32.

A keyboard 24 is provided for setting the allowed limits to said relationships and for other purposes needed to operate the installation.

As seen in FIG. 1, the installation further includes a shunt current-measurement device 33 between the DC power supply of the machine tool and the DC-AC converter transformer supplying three-phase power to a motor of the machine tool.

Optionally, alarm means 34, visible and audible are responsive to the display of any relationship falling outside the set limits.

The invention also provides a method for producing predictive maintenance data of rotating machinery, being particularly useful for machine tools operating under Computer Numerical Control (CNC), and having a plurality of motors driving various functions of said machine tool, said method comprising the steps

A. Providing a program and inserting a card containing said program into the computer controlling said machine tool.
B. Providing a multiplexing device (MUX) and electrically connecting said MUX to each motor and to said computer.
C. Measuring the motor+constant machine specific axis momentum of inertia (MOI) driven by each motor, and calculating inertial torque and frictional torque:
where:
T=Torque,
I=the motor+the constant machine specific axis Momentum of Inertia (MOI),
v=speed, and
t=time.

The method and apparatus according to the invention allow dynamic and static performance data to be derived without requiring the connection of an external inertial load to the specific machine's axis under test.

D. Successively running each motor alone from start to full speed and to unbraked stop. Switching means are provided for this purpose or in any other way combined Successively and parallel running.
E. Recording performance factors such as speed, current, voltage drop, time and torque at each motor shaft.
F. Calculating a plurality from the motor+constant machine specific axis acceleration the motor minus constant load current/torque, Torque/speed, current/speed input-power/speed, efficiency/speed results from stall up to max speed. Calculating a plurality from the motor+constant machine specific axis steady state running the motor minus constant load torque-spectrum analysis, speed spectrum analysis and oscillating torque. Calculating a plurality from the motor+machine specific axis load deceleration running the motor minus constant load friction torque/speed, friction torque spectrum analysis, friction speed spectrum analysis.
G. Setting allowed limits to relationships referred to in step F.
and
H. Displaying details of any relationship falling outside said limits.

In a preferable embodiment of the method, data relating to motor shaft position is obtained by establishing an electrical connection between the computer and the motor shaft encoder, already assembled to said motor during manufacture of the machine tool.

In a further embodiment of the method, the relationships limits referred to in step G. are preset by the manufacturer of the machine tool.

In another embodiment of the method step H. includes the activation of an alarm responsive to receipt of an out-of-bounds relationship.

Advantageously the method includes printing out results, preferably in graphical form.

Referring now to FIG. 2, there is seen one of the motors of a CNC milling machine. The motor is fitted by the manufacturer with shaft position encoder. In the method of the invention data relating to motor shaft position is obtained by establishing an electrical connection between the motor shaft encoder already assembled to the motor during manufacture of the machine tool and the computer.

Seen in FIG. 3 is a CNC milling machine which is provided with a data acquisition installation. Data collected from each motor includes voltage drop, current and speed. The data is processed in the machine computer and is periodically examined by maintenance personnel. A major deviation from an established relationship, for example a fall in the value of torque/power, is recorded for investigation and a possible need for planned maintenance action.

As the data acquisition installation is installed during manufacture of the machine tool the wiring thereof will be partly routed through the hollow casing of the machine tool, and the software program will be integrated with the programs already running in the machine computer. Thus the quantity of external wiring is reduced and a better looking machine can be marketed at lower cost.

The scope of the described invention is intended to include all embodiments coming within the meaning of the following claims. The foregoing examples illustrate useful forms of the invention, but are not to be considered as limiting its scope, as those skilled in the art will be aware that additional variants and modifications of the invention can readily be formulated without departing from the meaning of the following claims.

1-12. (canceled)

13. A method for producing predictive maintenance data of a motorized machine, the machine having a motor connected to a constant load, the method comprising the steps of:
a) providing the motor with a mechanism which measures rotational speed of a motor axis within the motor;
b) accelerating said motor with the constant load from zero speed to a maximum speed and decelerating the motor with the constant load from said maximum speed to zero speed;
c) during said accelerating and said decelerating, sampling in time the rotational speed of the motor with the constant load, thereby determining absolutely or proportionally based on differentiating said sampling, at least one characteristic of the motor, said at least one characteristic selected from the group consisting of: dynamic torque-speed, dynamic torque-time, static torque-time, static torque-speed, friction torque-speed, friction torque-time, and friction torque spectrum; and d) comparing said at least one characteristic to at least one allowed limit.

14. The method of claim 1, further comprising the step of:
e) during said accelerating and said decelerating, measuring current and voltage thereby determining absolutely or proportionally at least one electrical characteristic selected from the group consisting of: current-torque, efficiency-speed and power input-speed.

15. The method of claim 1, further comprising the step of, subsequent to said accelerating and prior to said decelerating:
e) maintaining a steady state condition at maximum speed and thereby determining absolutely or proportionally at least one steady-state characteristic selected from the group consisting of: oscillating torque-speed, speed spectrum and torque spectrum

16. The method of claim 1, further comprising the step of:
f) presetting said at least one allowed limit by the user of the machine tool.

17. The method of claim 1, further comprising the step of:
f) displaying a detail of said at least one characteristic when said at least one characteristic is out of said at least one allowed limit.

18. The method of claim 1, further comprising the step of:
f) activating an alarm when said at least one characteristic is out of said at least one allowed limit.

19. The method of claim 1, wherein the motorized machine includes a plurality of motors each said motor having a corresponding encoder, the method further comprising the step of
h) providing a multiplexing device (MUX) which electrically connects said encoders to the computer.

20. A data acquisition system for predictive maintenance data of a machine tool, the machine tool having a plurality of motors, the system comprising:
a) for each motor, wherein a measurement mechanism which measures rotational speed is operatively connected to the motor shaft of each motor, said measurement mechanism providing an indication of rotational speed of the motor shaft;
b) a multiplexing device (MUX) which electrically connects said measurement mechanism to a computer;
c) a switching means for successively accelerating each motor from zero speed to maximum speed and for decelerating from maximum speed to zero speed;
d) a sampling means for sampling in time the rotational speed of the motors during said accelerating and said decelerating;
e) a calculating means for calculating absolutely or proportionally for each motor at least one characteristic based on differentiating said sampling, said at least one characteristic selected from the group consisting of: dynamic torque-speed, dynamic torque-time, static torque-time, static torque-speed, friction torque-speed, friction torque-time, and friction torque spectrum;
f) a recording means for recording said at least one characteristic; g) setting means for setting at least one allowed limit for said at least one characteristic.

21. The system of claim 20, further comprising a electrical measurement mechanism which measures current and voltage during said accelerating and said decelerating, thereby determining absolutely or proportionally at least one electrical characteristic selected from the group consisting of: current-torque, efficiency-speed and power input-speed.

22. The data acquisition system of claim 20, wherein subsequent to said accelerating and prior to said decelerating a steady state condition is maintained at maximum speed and during said steady state condition at least one of oscillating torque-speed, speed spectrum and torque spectrum is measured absolutely or proportionally.

23. The data acquisition system, according to claim 20, wherein said measurement mechanism is assembled with said motor during manufacture of said machine tool.

24. The data acquisition system, according to claim 20, wherein said measurement mechanism is retrofitted with said motor subsequent to manufacture of said machine tool.

25. The data acquisition system, according to claim 20, wherein said at least one allowed limit is preset by the manufacturer of said machine tool.

26. The installation as claimed in claim 20, further comprising
h) shunt current-measurement device disposed between the DC power supply the machine tool and the DC-AC inverter supplying three-phase power to at least one of the motors of the machine tool.

27. A computer numerical control (CNC) machine tool provided with a data acquisition system of claim 20.
